(19) United States
(12) Patent Application Publication
(10) Pub. No.: US 2025/0373736 A1
(43) Pub. Date: Dec. 4, 2025

(54) INTELLIGENT DEVICE CONNECTION LAYER UTILIZED WITH MULTI-FUNCTION DEVICE (MFD) SYSTEMS

(71) Applicant: Xerox Corporation, Norwalk, CT (US)

(72) Inventors: David A. Snell, Webster, NY (US); Arathi Krishnan, Kochi (IN); John Jacob Maju, Burnaby (CA); Richie J. Michelon, Tualatin, OR (US); Mark A. Sixbey, Rock Hill, SC (US)

(73) Assignee: Xerox Corporation, Norwalk, CT (US)

(21) Appl. No.: 18/680,624

(22) Filed: May 31, 2024

(51) Int. Cl. H04N 1/00

(52) U.S. Cl. CPC H04N 1/00029; H04N 1/00307; H04N 1/00315

(57) ABSTRACT

A method (500) for wirelessly connecting a mobile device (182) to a multi-function device (MFD) (100), comprising: scanning (530) for one or more MFDs within a vicinity of the mobile device; communicating (540), by the mobile device, a connection request to a device recognition system (400); receiving (550), by the mobile device from the device recognition system, connection instructions comprising instructions for connecting to one or more MFDs in the vicinity of the mobile device, wherein the instructions for connecting to the one or more MFDs are selected by the device recognition system using a trained MFD connection algorithm (464); and connecting (560), by the mobile device utilizing the connection instructions, to one of the one or more MFDs in the vicinity of the mobile device

### FIELD OF THE DISCLOSURE

The present disclosure is directed generally to networked multi-function devices (MFDs).

### BACKGROUND

A networked multi-function device (MFD) is a single device that provides more than one function. For example, the MFD may operate as a printer, copier, fax machine, and/or scanner, among other functions. Networked MFDs typically interact locally with a variety of different devices, including client computers, mobile devices, and other components that are connected to and communicate over a network.

It is often necessary or desirable to connect a mobile device such as a smartphone or tablet to an MFD for a variety of purposes. Mobile devices are increasingly used for work and personal tasks, including creating, reading, and editing documents. Connecting these devices to an MFD simplifies the process of printing, eliminating the need to first transfer files to a computer. Many MFDs support cloud-printing services which allow users to print documents from a mobile device, and in the reverse direction the user can utilize the MFD's scanning function to scan documents directly to the mobile device. Typically, the mobile device comprises an installed application (“app”) that facilitates connection of the device to the MFD.

However, connecting a mobile app to an MFD can be a difficult and frustrating process especially if the device is shared among many users. This is often handled by relying on a device-displayed QR-Code, an NFC tag, or by detecting the device over Wi-Fi or Bluetooth. In worst-case scenarios the user may be required to manually enter connection details for the device into the app. At best, there is a collection of static connection methods for the user to select from when trying to connect their mobile device to an MFD. However, these static connection methods may not work for a particular MFD, or there may be an error or issue that prevents the connection from being made. Troubleshooting the connection is also a very static process. Accordingly, connecting a mobile device/app to an MFD requires constant monitoring and troubleshooting by the owner of the mobile application and/or the MFD.

### SUMMARY OF DISCLOSURE

There is thus a continued need for methods and systems that facilitate connection of mobile devices/apps to multi-function devices (MFD) in a dynamic manner.

Various embodiments and implementations are directed to a multi-function device (MFD) system, comprising or in communication with a mobile device/application, configured to streamline the connection of a mobile device/app to an MFD. The mobile device or another component of the system scans for MFD(s) within the vicinity of the mobile device, to identify potential connections. The mobile device communicates a connection request to a device recognition system, which includes information about an MFD connection application utilized by the mobile device to connect to one or more MFDs, one or more MFD connection protocols available to the mobile device, a user identifier, and/or other information. In return, the device recognition system sends connection instructions to the mobile device, which includes instructions for connecting to the MFD in the vicinity of the mobile device. These connection instructions are selected by the device recognition system using a trained MFD connection algorithm. The mobile device can then use the received connection instructions to connect to the identified MFD. If there are issues with the connection, the mobile device and device recognition system can further utilize the trained MFD connection algorithm to troubleshoot the connection.

According to an aspect, a method for wirelessly connecting a mobile device to a multi-function device (MFD) is provided. The method includes: scanning for one or more MFDs within a vicinity of the mobile device, wherein scanning for an MFD comprises searching for a signal transmitted by one or more MFDs within a vicinity of the mobile device; communicating, by the mobile device, a connection request to a device recognition system, the connection request comprising at least: (1) information about an MFD connection application utilized by the mobile device to connect to one or more MFDs; (2) one or more MFD connection protocols available to the mobile device; (3) a user identifier; receiving, by the mobile device from the device recognition system, connection instructions comprising instructions for connecting to one or more MFDs in the vicinity of the mobile device, the connection instructions selected by the device recognition system based at least in part on the connection request communicated by the mobile device, wherein the instructions for connecting to the one or more MFDs are selected by the device recognition system using a trained MFD connection algorithm; and connecting, by the mobile device utilizing the received connection instructions, to one of the one or more MFDs in the vicinity of the mobile device.

In accordance with an embodiment, scanning for one or more MFDs comprises obtaining (122), by the mobile device, an MFD code of the one or more MFDs.

In accordance with an embodiment, the signal transmitted by one or more MFDs comprises one or more of a Bluetooth signal, an NFC signal, a Wi-Fi signal, a cellular signal, and an RFID signal.

In accordance with an embodiment, the method further includes the step of identifying, based on said scanning, one or more MFDs within the vicinity of the mobile device.

In accordance with an embodiment, the method further includes the step of receiving, from a user of the mobile device, a selection of one of the one or more identified MFDs, wherein the connection request further comprises: (4) an identification of the selected one of the one or more identified MFDs.

In accordance with an embodiment, scanning comprises GPS coordinates or visual object recognition to identify the one or more MFDs within the vicinity of the mobile device.

In accordance with an embodiment, the connection instructions comprise user interface instructions to adapt a user interface of the MFD connection application utilized by the mobile device, wherein the instructions to adapt the user interface are selected to simplify connection of the mobile device to the one of the one or more MFDs.

In accordance with an embodiment, scanning for one or more MFDs within a vicinity of the mobile device fails to identify an MFD.

In accordance with an embodiment, the method further includes the step of communicating, after the mobile device connects to the one of the one or more MFDs, connection status information to the device recognition system, wherein the connection status information is utilized to further train the device recognition system.

In accordance with an embodiment, the mobile device is unable to connect to the one of the one or more MFDs in the vicinity of the mobile device utilizing the received connection instructions, and the method further includes the steps of: communicating, by the mobile device to the device recognition system, connection failure information indicating a failure of the mobile device to connect to the one of the one or more MFDs in the vicinity of the mobile device; and receiving, by the mobile device from the device recognition system, connection troubleshooting instructions, wherein the connection troubleshooting instructions are selected by the device recognition system using the trained MFD connection algorithm.

In accordance with another aspect is provided a device recognition system configured to facilitate a wireless connection between a mobile device a multi-function device (MFD), wherein the mobile device is scanning for one or more MFDs within a vicinity of the mobile device, wherein scanning for an MFD comprises searching for a signal transmitted by one or more MFDs within a vicinity of the mobile device. The device recognition system comprises: a trained MFD connection algorithm configured to select, for a mobile device, instructions for connecting to one or more MFDs, wherein the instructions for connecting are selected by the trained MFD connection algorithm to have a highest likelihood of successfully connecting the mobile device to the one or more MFDs; and a communication interface configured to: receive a connection request from the mobile device, the connection request comprising at least: (1) information about an MFD connection application utilized by the mobile device to connect to one or more MFDs; (2) one or more MFD connection protocols available to the mobile device; (3) a user identifier; and transmit, to the mobile device, connection instructions comprising instructions for connecting to one or more MFDs in the vicinity of the mobile device, the connection instructions selected by the trained MFD connection algorithm.

In accordance with an embodiment, the connection request further comprises: (4) a selection, by a user of the mobile device, of one of the one or more identified MFDs identified by the mobile device via said scanning.

In accordance with an embodiment, the communication interface is further configured to receive, after the mobile device connects to the one of the one or more MFDs, connection status information, wherein the connection status information is utilized to further train the MFD connection algorithm.

In accordance with an embodiment, the communication interface is further configured to: receive, from the mobile device, connection failure information indicating a failure of the mobile device to connect to the one of the one or more MFDs in the vicinity of the mobile device; and communicate, to the mobile device, connection troubleshooting instructions, wherein the connection troubleshooting instructions are selected by the device recognition system using the trained MFD connection algorithm.

In accordance with another aspect is provided a multi-function device (MFD) system configured to wirelessly connect to a mobile device. The MFD system comprises: one or more MFDs; and a device recognition system remote from the one or more MFDs and comprising a trained MFD connection algorithm configured to select, for the mobile device, instructions for connecting to one or more MFDs, wherein the instructions for connecting are selected by the trained MFD connection algorithm to have a highest likelihood of successfully connecting the mobile device to the one or more MFDs; wherein the device recognition system is configured to: receive a connection request from the mobile device, the connection request comprising at least: (1) information about an MFD connection application utilized by the mobile device to connect to one or more MFDs; (2) one or more MFD connection protocols available to the mobile device; (3) a user identifier; transmit, to the mobile device, connection instructions comprising instructions for connecting to one of the one or more MFDs, the connection instructions selected by the trained MFD connection algorithm.

In accordance with an embodiment, the connection request further comprises: (4) a selection, by a user of the mobile device, of one of the one or more identified MFDs identified by the mobile device via said scanning.

In accordance with an embodiment, the device recognition system is further configured to receive, after the mobile device connects to the one of the one or more MFDs, connection status information, wherein the connection status information is utilized to further train the MFD connection algorithm.

In accordance with an embodiment, the device recognition system is further configured to: receive, from the mobile device, connection failure information indicating a failure of the mobile device to connect to the one of the one or more MFDs in the vicinity of the mobile device; and communicate, to the mobile device, connection troubleshooting instructions, wherein the connection troubleshooting instructions are selected by the device recognition system using the trained MFD connection algorithm.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. The figures showing features and ways of implementing various embodiments and are not to be construed as being limiting to other possible embodiments falling within the scope of the attached claims. Also, the drawings are not necessarily to scale, emphasis instead generally being placed upon illustrating the principles of the various embodiments.

FIG. 1 is a schematic representation of an MFD, in accordance with an embodiment.

FIG. 2 is a schematic representation of a fleet of MFDs, in accordance with an embodiment.

FIG. 3 is a schematic representation of an MFD, in accordance with an embodiment.

FIG. 4 is a schematic representation of device recognition system, in accordance with an embodiment.

FIG. 5 is a flowchart of a method for connecting a mobile device to an MFD, in accordance with an embodiment.

FIG. 6 is a flowchart of a method for training an MFD connection model, in accordance with an embodiment.

### DETAILED DESCRIPTION OF EMBODIMENTS

Various embodiments and implementations are directed to methods and systems to facilitate connection of a mobile device to a multi-function device (MFD). More generally, Applicant has recognized and appreciated that it would be beneficial to provide a method and system to efficiently optimize the MFD connection process. The mobile device or another component of the system scans for MFD(s) within the vicinity of the mobile device, to identify potential connections. The mobile device communicates a connection request to a device recognition system, which includes information about an MFD connection application utilized by the mobile device to connect to one or more MFDs, one or more MFD connection protocols available to the mobile device, a user identifier, and/or other information. In return, the device recognition system sends connection instructions to the mobile device, which includes instructions for connecting to the MFD in the vicinity of the mobile device. These connection instructions are selected by the device recognition system using a trained MFD connection algorithm. The mobile device can then use the received connection instructions to connect to the identified MFD. If there are issues with the connection, the mobile device and device recognition system can further utilize the trained MFD connection algorithm to troubleshoot the connection.

According to an embodiment, rather than rely on a static if/then list of connection or troubleshooting methods, the methods and systems described or otherwise envisioned herein connect to an AI-supported system that provides the most up-to-date connection and troubleshooting methods at any time. The system learns from requests coming in as well as the initial data sets provided to determine what are the best-in terms of simplest and most likely to succeed in making a connection-methods to provide to the user. The system can also recommend additional methods to the user if initial methods were not successful, and can utilize information provided from the user or the user's device which can be processed to more directly target the best connection and troubleshooting methods.

The embodiments and implementations disclosed or otherwise envisioned herein can be utilized with any system that may utilize or benefit from automated support tools for connection. For example, one application of the embodiments and implementations disclosed or otherwise envisioned herein is automated support tools for multi-function devices. One application is to improve connection of mobile devices to Xerox® multi-function devices, among other products. However, the disclosure is not limited to these devices or systems, and thus the disclosure and embodiments disclosed herein can encompass any system that may utilize or benefit from automated support tools for connection.

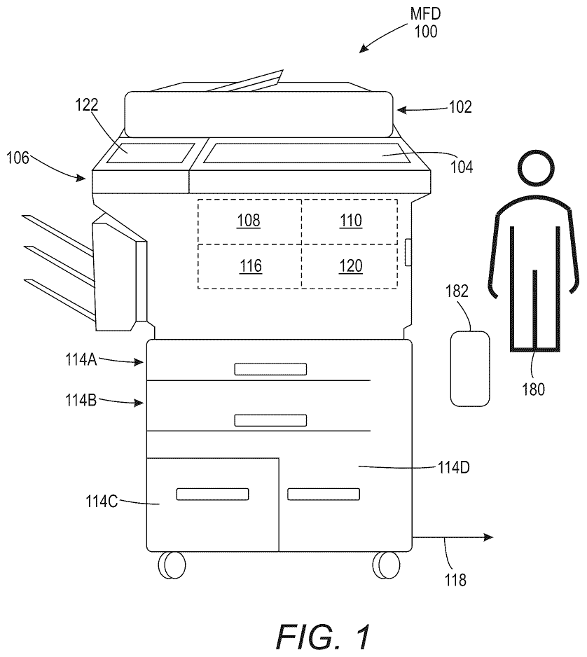

Referring to FIG. 1, in one embodiment, is a multi-function device (MFD), such as a multi-function printer (MFP). As described herein, such devices combine the capabilities of photocopiers, printers, scanners and, optionally, fax machines in one unit, acting as a hub for many of the user's document processing needs. For example, with reference to FIG. 1, an exemplary multi-function device 100 that is a multi-function printer is illustrated in accordance with certain aspects of the present disclosure. The multi-function device 100 may be a printing apparatus of the type suitable for use with the present disclosure. In embodiments, the multi-function device 100 can utilize both hardware components and software to perform one or more tasks such as printing, scanning, faxing, copying, and/or file sharing. Put another way, the multi-function device 100 can provide one or more services, such as a printing service, a scanning service, a faxing service, a copying service, a file sharing service, and/or the like. In the example of FIG. 1, the multi-function device 100 comprises a document feeder 102, a user interface 104, an image reading device 106, an image forming device 108, a duplex unit 110, an output device 122, one or more paper cassettes 114A, 114B, 114C, 114D, and a controller 116 including one or more software components for controlling the device 100. The multi-function device 100 may be connected to a network via a network connection 118. In embodiments, the multi-function device 100 may comprise one or more replaceable units 120, including but not limited to, ink or toner cartridges, a laser image forming apparatus (which may include an electric charging unit), a transfer unit, a fusing unit, one or more rollers or belts, and/or the like.

As mentioned above, the multi-function device 100 can provide one or more services, such as a printing service, a scanning service, a faxing service, a copying service, a file sharing service, and/or the like. In embodiments, the controller 116 may be configured to provide one or more of these services. For example, in some embodiments, the controller 116 may be used to implement a printing path schedule based on one or more print orders. The multi-function device 100 may be capable of simplex and/or duplex output, in which a stream of images (or digital video signals representative of images) desired to be printed causes the desired images to be formed on a selected side of a print sheet.

In further embodiments, after one or more scanning/copying parameters may be entered via the user interface 104, the controller 116 may operate the document feeder 102 in order to convey a document to be scanned or copied to a predetermined reading position on image reading device 106. In particular embodiments, the image reading device 106 can illuminate the document conveyed to the reading position thereof, such that the resulting reflection from the document is transformed into a corresponding electric signal, or image signal, by a solid state imaging device (e.g., a Charge Coupled Device (CCD) image sensor). After the document has been read, the controller 116 may operate the multi-function device 100 to drive the document away from the reading position. In embodiments, the image forming device 108 can then form an image represented by the image signal on a printer substrate (or print media) by an electrophotographic (i.e., xerographic), thermosensitive, heat transfer, ink jet and/or similar system.

When providing a copying service, a printer substrate or print media may be fed from one or more paper cassettes 114A, 114B, 114C, 114D to the image forming device 108. In some embodiments, the duplex unit 110 may be operatively arranged to turn over the printer substrate carrying an image on one side of thereof and again feed it to the image forming device 108. As a result, an image can be formed on both sides of the printer substrate in order to complete a duplex copy.

Although certain services such as printing and copying services have been described herein, it should be appreciated that other services such as scanning, faxing, and file sharing may also be provided. For example, in the case of a scanning service, an image signal produced as described above may be digitally rendered into a file that can be transmitted (e.g., via the network connection 118) to another device, such as a remote server or directly to a user's computer.

It should be noted that in certain embodiments of the systems, devices, and methods described or otherwise envisioned herein, reference to a “multi-function device” or “MFD” can also or alternatively include or comprise a single-function device (SFD). According to an embodiment, a “single-function device” or “SFD” is a device that only prints and does not have or comprise scanning/copying/faxing or other functions related to those hardware capabilities. Alternatively, the SFD may perform another singular function such as copying and does not have or comprise scanning/printing/faxing or other functions. Alternatively, the SFD may perform another singular function such as scanning and does not have or comprise printing/copying/faxing or other functions. Other variations are possible. Thus, the terms “multi-function device” and “MFD” are defined to mean a device that is designed or configured to perform a single function as described or otherwise envisioned herein, as well as a device that is designed or configured to perform multiple functions as described or otherwise envisioned herein.

Also referring to FIG. 1 is a user 180 of the MFD or other component of the system. For example, user 180 may utilize or possess a mobile device 182 which can wirelessly connect to the MFD. The mobile device can be any device that can be mobile, handheld, or otherwise not fixed in one place. Examples of mobile devices include smartphones, tablets, wearables such as smartwatches, and many other devices. The mobile device 182 may comprise—or be capable of comprising—an application (“app”) that facilitates utilization of the MFD by the mobile device and the user. The application is a piece of software programmed to perform one or more specific tasks on the mobile device.

The mobile device may connect to the MFD for a variety of purposes. For example, the mobile device may be utilized to provide documents to the MFD for printing, faxing, or for other purposes. The mobile device may be utilized to receive documents from the MFD, such as scanned documents or images. Many other functions are possible. Accordingly, the application may be programmed or otherwise designed to facilitate some or all of these functions, as well as other possible functions. The application may be downloaded and installed on the mobile device from a variety of sources.

In particular embodiments, a location may comprise a fleet of MFDs 100, which may be utilized by different groups or departments in a location, or may be used to coordinate or otherwise distribute one or more services. For example, in some embodiments, a fleet of devices may include a first multi-function device that specializes in high-capacity printing jobs, a second multi-function device that specializes in scanning documents, and a plurality of multi-function devices configured to every-day printing, scanning, copying, faxing, and/or file sharing needs.

As another example, a first MFD may be located at a first location in proximity to a first subset of users, and a second MFD may be located at a second location in proximity to a second subset of users, and so on. Thus, a user may be assigned to a specific MFD in the fleet of MFDs, or the user may want to connect to a specific MFD in the fleet of MFDs to assist with a task. These and other arrangements are possible in accordance with aspects of the present disclosure.

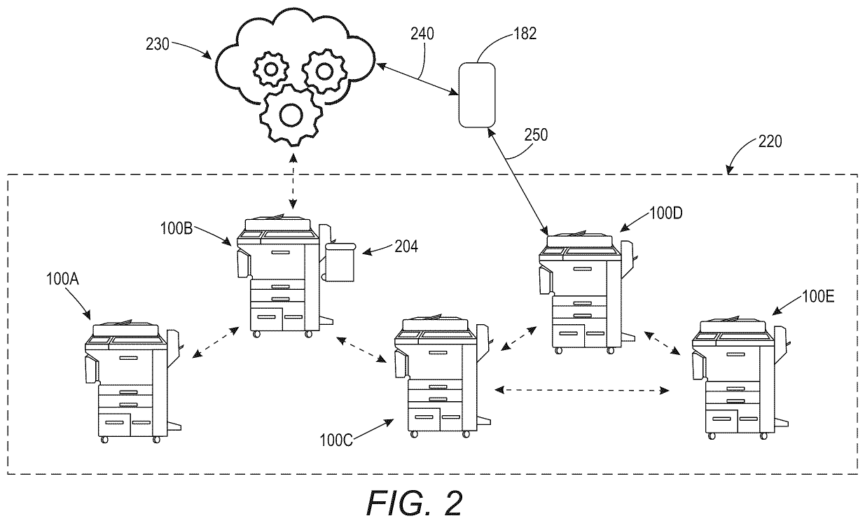

Referring to FIG. 2, a fleet 220 of MFDs 100A-100E is illustrated in accordance with certain aspects of the present disclosure. In particular embodiments, the MFDs 100A-100E may be shared between a plurality of users such that a user may select one or more of the devices 100A-100E for a specific service. For example, the fleet 220 of MFDs 100A-100E may be distributed across an organization's office building, and a user (not shown) may select device 100D to complete a printing service because it is the closest device among the fleet 220. However, it should be appreciated that the fleet 220 of MFDs 100A-100E is not required to be within the same building, but may be distributed more broadly and securely connected remotely via wired and/or wireless network connections. In embodiments, each of the MFDs 100A-100E can be a multi-function printer connected via wired and/or wireless network connections in accordance with a variety of possible topologies. As shown in the example of FIG. 2, device 100A is connected with device 100B, device 100B is connected with devices 100A, 100C, device 100C is connected with devices 100B, 100D, 100E, device 100D is connected with devices 100C, 100E, and device 100E is connected with devices 100C, 100D.

With further reference to FIG. 2, the fleet 220 of MFDs 100A-100E may be connected to and/or in communication with a remote central processor 230 that connects or otherwise facilitates communication between, and/or monitoring of, the MFDs. Thus, one or more of the one or more MFDs 100 in the system communicate monitoring data to the remote central processor either continuously or periodically, via any communication network. Additionally, the remote central processor 230 may communicate information to one or more of the MFDs, including information about executing functionality of the MFD. As an example, the remote central processor 230 may communicate a print job to an MFD from a user, a mobile device, or another source. Notably, according to an embodiment, the remote central processor may be remote from the MFDs, as in a component of the system other than an MFD, but may be located on-site with the MFDs being monitored. For example, the central processor may be a “back room” processor, server, or other component performing the monitoring of the MFDs.

With further reference to FIG. 2, a mobile device 182 may communicate with one or more MFDs in the fleet 220 of MFDs 100A-100E. Communication may be accomplished directly or via an app installed on the mobile device. The communication may be used to perform one or more of the functions described or otherwise envisioned herein. The mobile device may communicate with one or more of the MFDs directly via a wireless connection (i.e., Bluetooth, NFC, Wi-Fi, etc.), or it may communicate with one or more of the MFDs via the remote central processor 230.

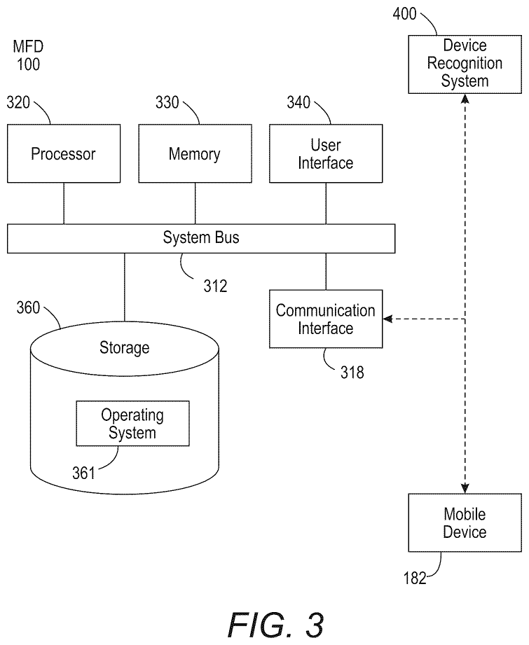

Referring to FIG. 3, in one embodiment, is a high-level schematic representation of a multi-function device 100. Referring to an embodiment of MFD 100 as depicted in FIG. 3, for example, the system comprises one or more of a processor or controller 320 including one or more software components for controlling the device 100, memory 330, user interface 340, communications interface 318, and storage 360, interconnected via one or more system buses 312. It will be understood that FIG. 3 constitutes, in some respects, an abstraction and that the actual organization of the components of the system may be different and more complex than illustrated. Additionally, MFD 100 can be any of the devices or systems described or otherwise envisioned herein. Other elements and components of MFD 100 are disclosed and/or envisioned elsewhere herein.

According to an embodiment, the MFD 100 comprises one or more user interfaces 340. The user interface 340 can be any user interface that enables user interaction with the MFD. For example, the user interface can be anything that allows information to be conveyed and/or received, and may include a display, a touchscreen, a mouse, and/or a keyboard for transmitting information and receiving user commands. In some embodiments, user interface 340 may include a command line interface or graphical user interface that may be presented to a terminal via communication interface 318. The user interface may be located with one or more other components of the MFD, or may be located remote from the MFD and in communication via a wired and/or wireless communications network.

According to an embodiment, the MFD 100 is in wired and/or wireless communication with a remote central processor 230 that connects or otherwise facilitates communication between, and/or monitoring of, the MFDs. As described or otherwise envisioned herein, the remote central processor 230 may facilitate communication between a mobile device and the MFD.

According to an embodiment, the MFD 100 is in wired and/or wireless communication with a mobile device 182. The mobile device may connect to the MFD for a variety of purposes. For example, the mobile device may be utilized to provide documents to the MFD for printing, faxing, or for other purposes. The mobile device may be utilized to receive documents from the MFD, such as scanned documents or images. Many other functions are possible.

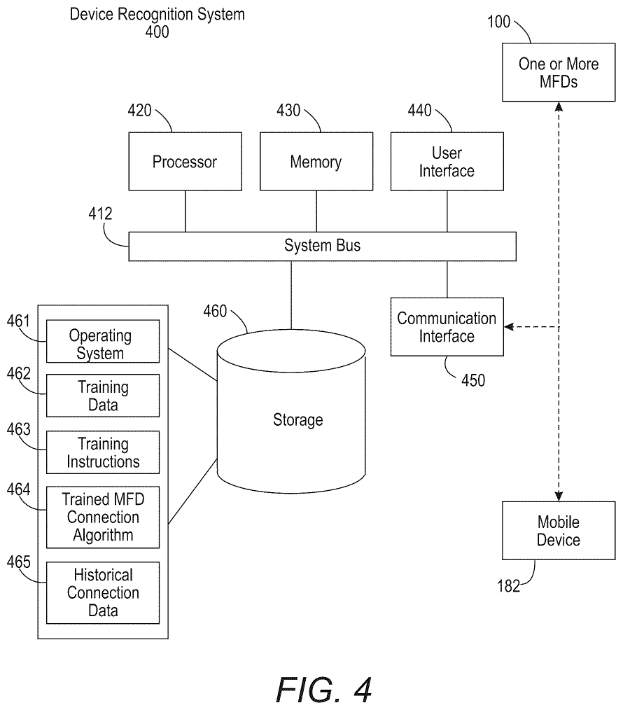

Referring to FIG. 4, in one embodiment, is a device recognition system 400. The device recognition system 400 as depicted in FIG. 4, for example, comprises one or more of a processor 420, memory 430, user interface 440, communications interface 450, and storage 460, interconnected via one or more system buses 412. It will be understood that FIG. 4 constitutes, in some respects, an abstraction and that the actual organization of the components of the system 400 may be different and more complex than illustrated. Additionally, system 400 can be any of the systems described or otherwise envisioned herein. Other elements and components of device recognition system 400 are disclosed and/or envisioned elsewhere herein.

According to an embodiment, device recognition system 400 is in wired and/or wireless communication with one or more local and/or remote multi-function devices (MFDs) 100. The term “multi-function device” refers to a single device or a combination of multiple devices configured to perform one or more functions such as, but not limited to, scanning, printing, copying, imaging, and the like. The multi-function device includes software, hardware, firmware, or a combination thereof. The MFD can be any device connected to the device recognition system 400 via a wired and/or wireless local and/or remote connection such as a local network, the internet, or any other connection. The MFD can be a home device, a business device, or any other device. The MFD can be a device that performs one or more functions, such as printing, copying, scanning, faxing, emailing, and more. MFDs, such as those offered by Xerox®, can include or comprise tablet-like touchscreen interfaces among other types of user interfaces, mobile-and cloud-readiness, copier data security, managed print services integration, customized apps, Wi-Fi connectivity, and much more. MFDs can perform many different workflows, including routing documents for electronic signature or approval, automating repetitive processes, creating custom flows that integrate with back-office systems, scanning stacks of paper into digital files that are easy to search, share and store, and printing from—or scan to—local and/or cloud-based repositories. There are many other possible MFDs, and MFD functionalities.

In accordance with one possible embodiment, the device recognition system 400 is in communication with a plurality of MFDs 100. The plurality of MFDs may be local to the other components of the device recognition system, may be remote to the other components of the device recognition system, or may be a combination of local and remote to the device recognition system. The plurality of MFDs may thus be located in a single local or remote location, or may be distributed among a plurality of locations.

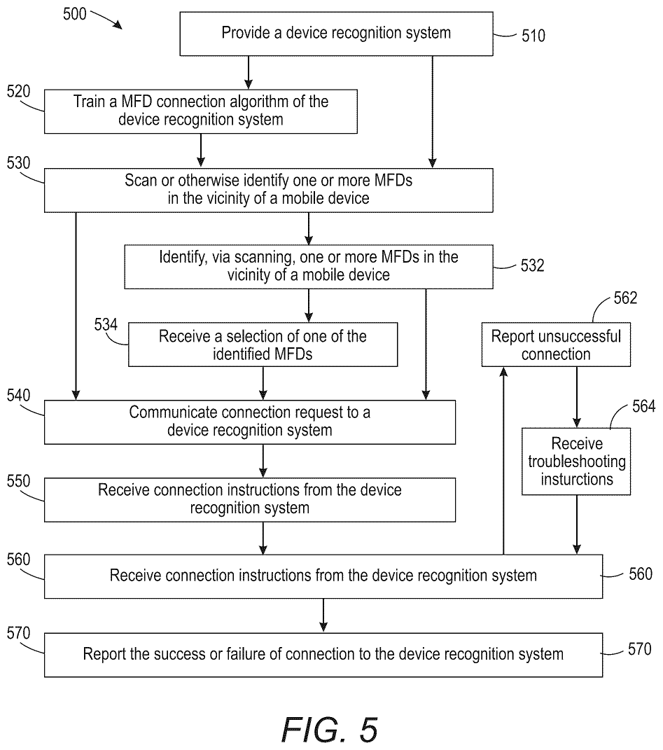

Referring to FIG. 5, in one embodiment, is a flowchart of a method 500 for wirelessly connecting a mobile device to a multi-function device. The methods described in connection with the figures are provided as examples only, and shall be understood not to limit the scope of the disclosure. The system can be any of the systems described or otherwise envisioned herein. The system can be a single system or multiple different systems.

At step 510 of the method, a device recognition system 400 is provided. The device recognition system can be system 400 as depicted in FIG. 4, although other device recognition systems are possible. Thus, device recognition system 400 can be any of the systems described or otherwise envisioned herein. Other elements and components of device recognition system 400 are disclosed and/or envisioned elsewhere herein.

As described elsewhere herein, at step 520 of the method, an MFD connection algorithm or model is trained to provide a mobile device with connection instructions configured to facilitate connection of a mobile device to one or more MFDs in the vicinity of the mobile device. The MFD connection algorithm or model may also be trained to provide connection troubleshooting to the mobile device. The MFD connection algorithm or model is further described herein, as is the process for training the MFD connection algorithm.

At step 530 of the method, a user desires to have a mobile device connect to an MFD for any of the reasons described or otherwise envisioned herein. Accordingly, a component of the system scans for one or more MFDs within a vicinity of the mobile device. The ‘vicinity’ can be a predetermined distance such as within a certain number of feet or meters, within a particular building or space, or a variety of other distances. The scanning can be triggered by the user such as via an action taken on the mobile device or via a mobile device app, or the scanning can be triggered automatically by the system. For example, the scanning can be triggered periodically, or the scanning can be triggered by opening of the app on the mobile device, by manipulation of documents on the mobile device, or via a variety of other mechanisms. Many other triggers are possible.

The scanning can be performed by a variety of different components of the system. According to an embodiment, the scanning is performed by the mobile device 182, the device recognition system 400, an MFD 100, or by any other component of the system.

The scanning can be performed in a wide variety of ways. According to an embodiment, scanning for an MFD comprises searching for a signal transmitted by one or more MFDs within a vicinity of the mobile device. For example, an MFD or another component of the system could be configured to transmit identifying or other information via a signal such as a Bluetooth signal, an NFC signal, a Wi-Fi signal, a cellular signal, an RFID signal, or any other signal. While these transmitted signals may not be suitable for data transfer and continuous communication (for example, NFC), the signal can be used as a method to identify and pair an MFD with a mobile device. According to an embodiment, another communication protocol such as Bluetooth or Wi-Fi could then be utilized for data transfer and continuous communication.

According to another embodiment, scanning for an MFD comprises obtaining, by the mobile device, an MFD code of the one or more MFDs. For example, the mobile device could recognize an MFD code for an MFD, such as a QR code or other displayed code. The MFD could comprise this MFD code as a visible displayed code, and the mobile device could capture the visibly displayed code using a camera of the device or any other camera. The code would then be utilized by the mobile device (such as by the mobile app), or by another component of the system, to identify the MFD.

According to another embodiment, scanning for an MFD comprises utilization of GPS coordinates or visual object recognition to identify the one or more MFDs within the vicinity of the mobile device. For example, the mobile device may comprise location-aware functionality that could be combined with the system—such as device recognition system 400—to identify MFD(s) within the vicinity of that known location. According to an embodiment, an MFD can be configured with GPS-relevant location information or capability, and the mobile device could use its own positioning in combination with the MFD positioning to find relevant MFD.

As another example, the mobile device may use visual object recognition, such as capturing images of the MFD using the camera of the mobile device or another camera, to identify the MFD within the vicinity of the mobile device. Accordingly, the MFD would comprise a physical visual characteristic that would uniquely identify the MFD.

According to another embodiment, scanning for an MFD fails to identify an MFD within a vicinity of the mobile device. For example, there may not be any MFDs in the vicinity, or there may be an error with the scanning and detection. Similarly, while scanning may identify an MFD, that MFD may not be a device that the user can or wants to use. This may result in a new scan, or other options as described or otherwise envisioned herein.

According to an embodiment, at optional step 532 of the method, one or more MFDs are identified within the vicinity of the mobile device. In other words, the scanning was successful and there are one or more MFDs that are identified as being within the vicinity of the mobile device.

Accordingly, at optional step 534 of the method, the system may receive a selection of one of the one or more MFDs identified as being within the vicinity of the mobile device. For example, the mobile device—alone or through the installed app—may comprise a user interface that provides a list of one or more identified MFDs. The user interface will comprise the ability for the user to select or otherwise identified one of these MFDs as being the MFD that the user wants to or will utilize for one or more of the functions described or otherwise envisioned herein.

At step 540 of the method, the mobile device communicates a connection request to the device recognition system 400. This request may be sent after identifying an MFD within the vicinity of the mobile device, or may be sent before or while the system is searching for the MFD. The connection request may be sent via any wired and/or wireless communication method such as cellular, Bluetooth, Wi-Fi, NFC, or any other communication protocol. According to an embodiment, the device recognition system 400 is located remotely from the mobile device, such as a remote cloud-based service, and thus the communication will occur from the mobile device to the remote device recognition system using one or more wired and/or wireless communication protocols.

According to an embodiment, the connection request comprises information about the mobile device or about the user that can be used by the system to facilitate connection between the mobile device and the MFD. For example, the connection request may comprise information such as: (1) information about the app that the mobile device is using or has available to use; (2) information about the user of the app and whether the system has any prior experience with that user (for example, what MFDs have the user connected to before and how); (3) what connection protocols the mobile device or app are allowed to use (for example, Bluetooth, Wi-Fi, etc.); (4) what connection protocols are not allowed but are available or possible (for example, Bluetooth is possible but the user has not provided permission to use the mobile device's Bluetooth); (5) MED model information which could be determined/provided by multiple methods including but not limited to: (a) directly entering MFD model number; (b) directly entering the MFD serial number; (c) a picture of the MFD for object recognition; (d) a picture of an MFD QR code; (e) a picture of a printed MFD configuration sheet; (f) a picture of an information page on the device UI; and the connection request may comprise (6) success or failure of connection methods as the connection method or troubleshooting progresses, among a great deal of other possible information.

According to one embodiment, the connection request sent by wired and/or wireless communication protocols from the mobile device to the device recognition system 400 comprises at least: (1) information about an MFD connection application utilized by the mobile device to connect to one or more MFDs; (2) one or more MFD connection protocols available to the mobile device; (3) a user identifier. Notably, in an embodiment in which the user selects an MFD for connection (such as described with regard to step 534), the connection request further comprises: (4) an identification of the selected one of the one or more identified MFDs.

At step 550 of the method, the mobile device receives connection instructions from the device recognition system in response to the communicated connection request. The connection instructions can be sent via any wired and/or wireless communication method such as cellular, Bluetooth, Wi-Fi, NFC, or any other communication protocol. According to an embodiment, the device recognition system 400 is located remotely from the mobile device, such as a remote cloud-based service, and thus the communication will occur from the remote device recognition system to the mobile device using one or more wired and/or wireless communication protocols.

According to an embodiment, the connection instructions sent from the device recognition system to the mobile device in response to the communicated connection request comprise instructions for connecting to one or more of the MFDs identified in the vicinity of the mobile device. The connection instructions may include, for example, a communication protocol to be used for the connection, identifying information for the MFD, security information for the MFD (which could be necessary to establish the connection), and other information. The connection instructions may also include information about connecting through the selected protocol. For example, that the device is on a WiFi network and the mobile device needs to connect to that WiFi network, thus it could provide information about the WiFi network via SSID and prompt for the user to login to it via their mobile device or automatically login if the mobile device already has credentials and is not already logged in. The connection instructions may further include other information.

According to an embodiment, the connection instructions comprise user interface instructions to adapt a user interface of the MFD connection application utilized by the mobile device. Thes instructions to adapt the user interface may be selected to simplify connection of the mobile device to the one of the one or more MFDs.

Once received by the mobile device, the connection instructions may be implemented immediately, or they may be stored in local or remote storage for future use.

According to an embodiment, the connection instructions are determined, created, selected, identified, or otherwise generated by a trained MFD connection algorithm or model (464) of the device recognition system 400. The MFD connection algorithm or model is trained to analyze a received connection request (as input to the model) to determine, create, select, identify, or otherwise generate connection instructions (as output of the model). The trained MFD connection algorithm can be any model that can be trained to utilize the input to generate the output, as described or otherwise envisioned herein. For example, the trained MFD connection algorithm can be a neural network or other trained machine learning model. Thus, according to an embodiment, the device recognition system 400 comprises a trained MFD connection algorithm 464 that receives the input data and outputs determined, created, selected, identified, or otherwise generated connection instructions. The trained MFD connection algorithm is unique based on the training data used to train the model. Once generated, the trained MFD connection algorithm 464 can be utilized immediately, or it may be stored in local and/or remote memory for future use.

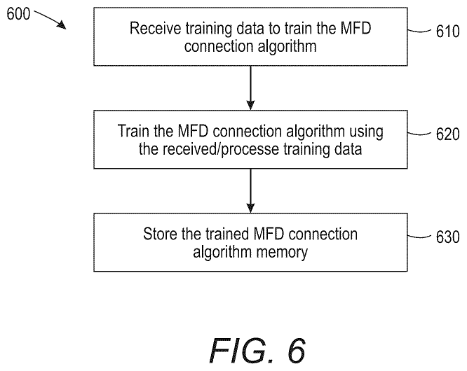

The MFD connection algorithm 464 can be trained in a variety of ways. Referring to FIG. 6, in one embodiment, is a flowchart of a method 600 for training the MFD connection algorithm 464. The method may be performed by the device recognition system 400, or may be performed by another system such as a specialized machine learning model training system.

At step 610 of the method, the training system receives training data which will be used to train the model. The training data can be any data sufficient to train the model to utilize the described input data to generate the described output. For example, the training data may comprise MFD connection data, parameters, or instructions that have previously been utilized in attempts to connect mobile devices to MFDs. Preferably, the training data will comprise MFD connection data, parameters, or instructions for a wide variety of different mobile devices, mobile applications, MFDs, and/or other variations of the system. This training data, which could be utilized in a supervised or unsupervised manner, can comprise MFD connection data for 100 s or 1000 s of MFD/mobile device connections or connection attempts, and so on. The training data may also comprise other information. This training data may be obtained and curated by an expert such as a technician or support specialist, or it may be obtained and curated under the supervision of a technician or support specialist, or it may be obtained and utilized without curation. The training data may be received from any source. For example, the training data may be received from a historical connection data database 465 of the device recognition system 400. The historical connection data database 280 may comprise the MFD connection data described or otherwise envisioned herein. According to an embodiment, the device recognition system 400 comprises or is in direct or indirect communication with a database which comprises some or all of the training data set.

According to an embodiment, the training system may comprise a data pre-processor or similar component or algorithm configured to process the received training data. For example, the data pre-processor analyzes the training data to remove noise, bias, errors, and other potential issues. The data pre-processor may also analyze the input data to remove low quality data. Many other forms of data pre-processing or data point identification and/or extraction are possible.

At step 620 of the method, the training system trains the MFD connection algorithm 464 to determine, create, select, identify, or otherwise generate connection instructions from input data (i.e., a received connection request), using the training data. The MFD connection algorithm is trained using any method for training such a model. The trained MFD connection algorithm is a unique model based on the training data used to train the model. Following training, the system comprises a trained MFD connection algorithm. Thus, following training, the MFD connection algorithm is a specialized model configured to receive the specialized input (such as a received connection request) and generate the very specific output, namely the connection instructions.

At step 630 of the method, the trained MFD connection algorithm is stored for future use. According to an embodiment, the trained MFD connection algorithm may be stored in local or remote storage.

There are many benefits to using a machine learning model or algorithm to generate connection instructions. For example, while it is possible for some methods to be pre-coded in an if/then methodology, this would not allow for the quick addition of new methods, nor would it handle user-specific context or information readily. A learning system constantly receives success/failure information from the various troubleshooting processes that are being used (and background information provided) and can thus dynamically revise or update the information that is being provided to the end user.

Accordingly, user-specific information can be incorporated into troubleshooting. If a specific user sends most of their printing going to a single printer and has an error getting their job to complete, the system can incorporate that user's profile data and target the troubleshooting. Additionally, new errors and problems can be found and/or entered at any time. The system can adjust troubleshooting on the fly rather than wait for a review and re-coding cycle. This means that the novel methods and systems described herein can provide the latest troubleshooting methods (and possibly reworked code) to a mobile app at any time. The mobile apps can receive the latest troubleshooting information prior to code compilation in case they are offline and unable to connect to the system. Further, a mobile app can download and replace the offline troubleshooting data when run with the latest information provided by the system.

As the system learns a user's usage it can determine if there is a workflow that would benefit the user and provide that workflow to the mobile app. As a non-limiting example of this, if a user is regularly performing a scan job but changes the default from 1-sided scan to 2-sided scan and the resolution from 200 dpi to 300 dpi, the system can provide the mobile app with a workflow to present to the user that has those parameters already set as the default. The user could decide whether they want these connection instructions.

The system is not limited to Xerox printers. The troubleshooting capabilities are expanded to non-Xerox printers as information is added and desired. The technology could thus be licensed or otherwise provided to MFD manufacturers for their mobile apps, and could also enable better management of mixed manufacturer fleets.

Additionally, a learning system can handle diverse forms of data. Rather than relying on specific error codes (which it could still utilize) it would be able to respond to natural language inputs from end users. The system could potentially process image data as well and perform Optical Character Recognition (OCR) or object recognition for troubleshooting clues. For example, when a user does not know what type of printer they want to connect to because it is old and/or the model badge is missing, by taking a picture the printer model can be found in the recognition portion of the system such that model-specific troubleshooting methods are utilized.

Returning to method 500 in FIG. 5, at step 560 of the method, the mobile device utilizes the received connection instructions to attempt to connect the mobile device to the one of the one or more MFDs in the vicinity of the mobile device. Since the connection instructions may comprise information such as what communications protocol to utilize, what device to best connect to, and more information, the mobile device will attempt to connect to the MFD using this provided information or instructions.

According to an embodiment, if the connection attempt is successful, the mobile device will form a connection with the MED and then the mobile device can be used to perform one or more of the MFD functions described or otherwise envisioned herein.

According to an embodiment, if the connection attempt is unsuccessful, the method may return to a previous step to retry connection, or the mobile device may send information to the device recognition system that the connection was unsuccessful. This may trigger the device recognition system, via the MFD connection algorithm, to send troubleshooting instructions back to the mobile device.

According to an embodiment, at optional step 570 of the method, if the mobile device successfully connects to the MFD or is unable to connect to the MFD, the mobile device can communicate connection status information to the device recognition system. This connection status information may indicate the success or failure of the connection, and may include information such as the speed of the connection formation, the speed of data transfer, the steps taken by the device or use to connect the mobile device to the MFD, and any other information relevant to the connection and/or to the device recognition system.

According to an embodiment, this connection status information will or can be utilized for future training of the MFD connection algorithm. For example, if the connection is successful then the connection status information can be used to train, re-train, or update the MFD connection algorithm. Similarly, if the connection is unsuccessful then the connection status information can be used to train, re-train, or update the MFD connection algorithm.

According to an embodiment, the mobile device is unable to connect to the MFD when using the received connection instructions. Thus, at optional step 562 of the method, the mobile device sends to the device recognition system 400 connection failure information indicating a failure of the mobile device to connect to the one of the one or more MFDs in the vicinity of the mobile device. The connection failure information may also include any other necessary or beneficial information.

At step 564 of the method, the mobile device receives, from the device recognition system, connection troubleshooting instructions. This may include any instructions or suggestions for troubleshooting that may enable the MFD connection. According to an embodiment, the connection troubleshooting instructions are selected by the device recognition system using the trained MFD connection algorithm.

For example, according to an embodiment, the method could be used to troubleshoot any process that the mobile device and/or app can perform. This could be triggered, for example, by the user selecting a help button/icon in the app when something does not seem to be working (for example, the user is trying to perform a scan). Selecting the help would initiate the troubleshooting and allow for data such as: (1) what workflow was the user's app attempting? (2) user-entered feedback/description of the problem, which may vary based on the mobile device's capabilities but could be text from direct entry or speech to text (for example, they could enter “I trying to scan from the printer”). The system could assist with a problem the MFD specifically is having. This could allow data such as user entered feedback) but could also allow for: (1) image recognition if the user takes a picture of the displayed error from a MFD UI, webpage, or printed output; and/or (2) error information that the MFD has already provided back to the mobile app. This could be part of the normal bi-directional information provided between the MFD and the mobile app and there is no reason for the system not to preemptively start processing the error behind the scenes in case the user will be impacted or wishes to deal with it. In cases that a known error inhibits a user's workflow (e.g., the printer is indicating an output paper jam and the user is initiating a print workflow) the system can provide feedback to the app so that the user can be notified (and initiate troubleshooting if desired). Errors that should not directly impact the user's workflow could be ignored until the user specifically wants to deal with them (e.g., the printer is showing an output paper jam but the user is setting up a scan workflow). The system could also be designed to provide the user with recommended workflow enhancements to assist them in their app usage, based on learning that the system does regarding that user's usage of the app). This would rely on additional usage information that the app would provide back to the system, such as whether the user performs a scan job or print job from the printer. Many other variations are possible.

Referring again to FIG. 3 is a schematic representation of an MFD 100. The MFD can be any of the devices described or otherwise envisioned herein, and may comprise any of the components described or otherwise envisioned herein. It will be understood that FIG. 3 constitutes, in some respects, an abstraction and that the actual organization of the components of MFD 100 may be different and more complex than illustrated.

According to an embodiment, MFD 100 comprises a processor 320 capable of executing instructions stored in memory 330 or storage 360 or otherwise processing data to, for example, perform one or more steps of the method. Processor 320 may be formed of one or multiple modules. Processor 320 may take any suitable form, including but not limited to a central processing unit (CPU), graphical processing unit (GPU), tensor processing unit (TPU), neural processing unit (NPU), microprocessor, microcontroller, multiple microcontrollers, circuitry, field programmable gate array (FPGA), application-specific integrated circuit (ASIC), a single processor, or plural processors.

Memory 330 can take any suitable form, including a non-volatile memory and/or RAM. The memory 330 may include various memories such as, for example L1, L2, or L3 cache or system memory. As such, the memory 330 may include static random access memory (SRAM), dynamic RAM (DRAM), flash memory, read only memory (ROM), or other similar memory devices. The memory can store, among other things, an operating system. The RAM is used by the processor for the temporary storage of data. According to an embodiment, an operating system may contain code which, when executed by the processor, controls operation of one or more components of MFD 100. It will be apparent that, in embodiments where the processor implements one or more of the functions described herein in hardware, the software described as corresponding to such functionality in other embodiments may be omitted.

User interface 340 may include one or more devices for enabling communication with a user. The user interface can be any device or system that allows information to be conveyed and/or received, and may include a display, a mouse, and/or a keyboard for receiving user commands. In some embodiments, user interface 340 may include a command line interface or graphical user interface that may be presented to a remote terminal via communication interface 350. The user interface may be located with one or more other components of the system, or may be located remote from the MFD 100 and in communication via a wired and/or wireless communications network.

Communication interface 350 may include one or more devices for enabling communication with other hardware devices. For example, communication interface 350 may include a network interface card (NIC) configured to communicate according to the Ethernet protocol. Additionally, communication interface 350 may implement a TCP/IP stack for communication according to the TCP/IP protocols. Various alternative or additional hardware or configurations for communication interface 350 will be apparent.

Storage 360 may include one or more machine-readable storage media such as read- only memory (ROM), random-access memory (RAM), magnetic disk storage media, optical storage media, hard disk drive (HDD), solid state drive (SSD), flash-memory devices, or similar storage media. In various embodiments, storage 360 may store instructions for execution by processor 320 or data upon which processor 320 may operate. For example, storage 360 may store an operating system 361 for controlling various operations of MFD 100.

It will be apparent that various information described as stored in storage 360 may be additionally or alternatively stored in memory 330. In this respect, memory 330 may also be considered to constitute a storage device and storage 360 may be considered a memory. Various other arrangements will be apparent. Further, memory 330 and storage 360 may both be considered to be non-transitory machine-readable media. As used herein, the term non-transitory will be understood to exclude transitory signals but to include all forms of storage, including both volatile and non-volatile memories.

While MFD 100 is shown as including one of each described component, the various components may be duplicated in various embodiments. For example, processor 320 may include multiple microprocessors that are configured to independently execute the methods described herein or are configured to perform steps or subroutines of the methods described herein such that the multiple processors cooperate to achieve the functionality described herein. Further, where one or more components of MFD 100 is implemented in a cloud computing system, the various hardware components may belong to separate physical systems. For example, processor 320 may include a first processor in a first server and a second processor in a second server. Many other variations and configurations are possible.

Although not shown in FIG. 3, the MFD comprises software and/or hardware components necessary to enact the functionality of the MFD. In embodiments, the MFD comprises paper tray(s), paper feeder(s), printer(s), scanner(s), fax component(s), email component(s), and/or other components.

According to an embodiment, MFD 100 is in direct or indirect communication with a device recognition system 400. The MFD may transmit data to the device recognition system 400 according to the methods described or otherwise envisioned herein. According to an embodiment, MFD 100 is in direct or indirect communication with a mobile device 182 as described or otherwise envisioned herein.

According to an embodiment, storage 360 of MFD 100 may store one or more algorithms, modules, and/or instructions to carry out one or more functions or steps of the methods described or otherwise envisioned herein. For example, storage 360 may comprise, among other instructions or data, operating system 361.

Referring again to FIG. 4 is a schematic representation of a device recognition system 400. System 400 may be any of the systems described or otherwise envisioned herein, and may comprise any of the components described or otherwise envisioned herein. It will be understood that FIG. 4 constitutes, in some respects, an abstraction and that the actual organization of the components of the system 400 may be different and more complex than illustrated.

According to an embodiment, system 400 comprises a processor 420 capable of executing instructions stored in memory 430 or storage 460 or otherwise processing data to, for example, perform one or more steps of the method. Processor 420 may be formed of one or multiple modules. Processor 420 may take any suitable form, including but not limited to a central processing unit (CPU), graphical processing unit (GPU), tensor processing unit (TPU), neural processing unit (NPU), microprocessor, microcontroller, multiple microcontrollers, circuitry, field programmable gate array (FPGA), application-specific integrated circuit (ASIC), a single processor, or plural processors.

Memory 430 can take any suitable form, including a non-volatile memory and/or RAM. The memory 430 may include various memories such as, for example L1, L2, or L3 cache or system memory. As such, the memory 430 may include static random access memory (SRAM), dynamic RAM (DRAM), flash memory, read only memory (ROM), or other similar memory devices. The memory can store, among other things, an operating system. The RAM is used by the processor for the temporary storage of data. According to an embodiment, an operating system may contain code which, when executed by the processor, controls operation of one or more components of system 400. It will be apparent that, in embodiments where the processor implements one or more of the functions described herein in hardware, the software described as corresponding to such functionality in other embodiments may be omitted.

User interface 440 may include one or more devices for enabling communication with a user. The user interface can be any device or system that allows information to be conveyed and/or received, and may include a display, a mouse, and/or a keyboard for receiving user commands. In some embodiments, user interface 440 may include a command line interface or graphical user interface that may be presented to a remote terminal via communication interface 450. The user interface may be located with one or more other components of the system, or may be located remote from the system and in communication via a wired and/or wireless communications network.

Communication interface 450 may include one or more devices for enabling communication with other hardware devices. For example, communication interface 450 may include a network interface card (NIC) configured to communicate according to the Ethernet protocol. Additionally, communication interface 450 may implement a TCP/IP stack for communication according to the TCP/IP protocols. Various alternative or additional hardware or configurations for communication interface 450 will be apparent.

Storage 460 may include one or more machine-readable storage media such as read- only memory (ROM), random-access memory (RAM), magnetic disk storage media, optical storage media, hard disk drive (HDD), solid state drive (SSD), flash-memory devices, or similar storage media. In various embodiments, storage 460 may store instructions for execution by processor 420 or data upon which processor 420 may operate. For example, storage 460 may store an operating system 461 for controlling various operations of system 400.

It will be apparent that various information described as stored in storage 460 may be additionally or alternatively stored in memory 430. In this respect, memory 430 may also be considered to constitute a storage device and storage 460 may be considered a memory. Various other arrangements will be apparent. Further, memory 430 and storage 460 may both be considered to be non-transitory machine-readable media. As used herein, the term non-transitory will be understood to exclude transitory signals but to include all forms of storage, including both volatile and non-volatile memories.

While system 400 is shown as including one of each described component, the various components may be duplicated in various embodiments. For example, processor 420 may include multiple microprocessors that are configured to independently execute the methods described herein or are configured to perform steps or subroutines of the methods described herein such that the multiple processors cooperate to achieve the functionality described herein. Further, where one or more components of system 400 is implemented in a cloud computing system, the various hardware components may belong to separate physical systems. For example, processor 420 may include a first processor in a first server and a second processor in a second server. Many other variations and configurations are possible.

According to an embodiment, device recognition system 400 comprises or is in direct or indirect communication with one or more MFDs 100. The one or more MFDs may be local to the other components of the device recognition system, may be remote to the other components of the device recognition system, or may be a combination of local and remote to the device recognition system. The plurality of MFDs may thus be located in a single local or remote location, or may be distributed among a plurality of locations.

According to an embodiment, the device recognition system 400 is in direct or indirect communication with a mobile device 182 as described or otherwise envisioned herein.

According to an embodiment, storage 460 of system 400 may store one or more algorithms, modules, and/or instructions to carry out one or more functions or steps of the methods described or otherwise envisioned herein. For example, storage 460 may comprise, among other instructions or data, training data 462, training instructions 463, trained MFD connection algorithm 464, and/or historical connection data 466.

According to an embodiment, the device recognition system 400 comprises training data 462, which may be utilized to train the MFD connection algorithm 464. The training data can be any data sufficient to train the model to utilize the described input data to generate the described output. For example, the training data may comprise MFD connection data, parameters, or instructions that have previously been utilized in attempts to connect mobile devices to MFDs. Preferably, the training data will comprise MFD connection data, parameters, or instructions for a wide variety of different mobile devices, mobile applications, MFDs, and/or other variations of the system. This training data, which could be utilized in a supervised or unsupervised manner, can comprise MFD connection data for 100 s or 1000 s of MFD/mobile device connections or connection attempts, and so on. The training data may also comprise other information. This training data may be obtained and curated by an expert such as a technician or support specialist, or it may be obtained and curated under the supervision of a technician or support specialist, or it may be obtained and utilized without curation. The training data may be received from any source. For example, the training data may be received from a historical connection data database 465 of the device recognition system 400. The historical connection data database 280 may comprise the MFD connection data described or otherwise envisioned herein. According to an embodiment, the device recognition system 400 comprises or is in direct or indirect communication with a database which comprises some or all of the training data set.

According to an embodiment, training instructions 463 direct the system to utilize training data 462 to train the MFD connection algorithm 464, as described or otherwise envisioned herein. The training instructions can direct the system to train the models in a supervised or unsupervised manner. Many methods for training the models are possible, as described or otherwise envisioned herein.

According to an embodiment, trained MFD connection algorithm 464 is a neural network or other trained machine learning model trained to analyze received connection requests (as input to the model) to determine or otherwise generate connection instructions (as output of the model). The trained MFD connection algorithm can be any model that can be trained to utilize the input to generate the output, as described or otherwise envisioned herein. Thus, according to an embodiment, the device recognition system 400 comprises a trained MFD connection algorithm 464 that receives the input data and outputs connection instructions. The trained MFD connection algorithm is unique based on the training data used to train the model.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

What is claimed is:

1. A method (500) for wirelessly connecting a mobile device (182) to a multi-function device (MFD) (100), comprising:
scanning (530) for one or more MFDs within a vicinity of the mobile device, wherein scanning for an MFD comprises searching for a signal transmitted by one or more MFDs within a vicinity of the mobile device;
communicating (540), by the mobile device, a connection request to a device recognition system (400), the connection request comprising at least: (1) information about an MFD connection application utilized by the mobile device to connect to one or more MFDs; (2) one or more MFD connection protocols available to the mobile device; (3) a user identifier;
receiving (550), by the mobile device from the device recognition system, connection instructions comprising instructions for connecting to one or more MFDs in the vicinity of the mobile device, the connection instructions selected by the device recognition system based at least in part on the connection request communicated by the mobile device, wherein the instructions for connecting to the one or more MFDs are selected by the device recognition system using a trained MFD connection algorithm (464); and
connecting (560), by the mobile device utilizing the connection instructions, to one of the one or more MFDs in the vicinity of the mobile device.

2. The method of claim 1, wherein scanning for one or more MFDs comprises obtaining, by the mobile device, an MFD code of the one or more MFDs.

3. The method of claim 1, wherein the signal transmitted by one or more MFDs comprises one or more of a Bluetooth signal, an NFC signal, a Wi-Fi signal, a cellular signal, and an RFID signal.

4. The method of claim 1, further comprising the steps of identifying (532), based on said scanning, one or more MFDs within the vicinity of the mobile device.

5. The method of claim 4, further comprising the step of receiving (534), from a user of the mobile device, a selection of one of the one or more identified MFDs, wherein the connection request further comprises: (4) an identification of the selected one of the one or more identified MFDs.

6. The method of claim 1, wherein scanning comprises GPS coordinates or visual object recognition to identify the one or more MFDs within the vicinity of the mobile device.

7. The method of claim 1, wherein the connection instructions comprise user interface instructions to adapt a user interface of the MFD connection application utilized by the mobile device, wherein the instructions to adapt the user interface are selected to simplify connection of the mobile device to the one of the one or more MFDs.

8. The method of claim 1, wherein scanning for one or more MFDs within a vicinity of the mobile device fails to identify an MFD.

9. The method of claim 1, further comprising the step of communicating (570), after the mobile device connects to the one of the one or more MFDs, connection status information to the device recognition system, wherein the connection status information is utilized to further train the device recognition system.

10. The method of claim 1, wherein the mobile device is unable to connect to the one of the one or more MFDs in the vicinity of the mobile device utilizing the received connection instructions, and further comprising the steps of:
communicating (562), by the mobile device to the device recognition system, connection failure information indicating a failure of the mobile device to connect to the one of the one or more MFDs in the vicinity of the mobile device; and
receiving (564), by the mobile device from the device recognition system, connection troubleshooting instructions, wherein the connection troubleshooting instructions are selected by the device recognition system using the trained MFD connection algorithm.

11. A device recognition system (400) configured to facilitate a wireless connection between a mobile device (182) and a multi-function device (MFD) (100), wherein the mobile device is scanning for one or more MFDs within a vicinity of the mobile device, wherein scanning for an MFD comprises searching for a signal transmitted by one or more MFDs within a vicinity of the mobile device, wherein the device recognition system comprises:
a trained MFD connection algorithm (464) configured to select, for a mobile device, instructions for connecting to one or more MFDs, wherein the instructions for connecting are selected by the trained MFD connection algorithm to have a highest likelihood of successfully connecting the mobile device to the one or more MFDs; and
a communication interface (450) configured to:
receive a connection request from the mobile device, the connection request comprising at least: (1) information about an MFD connection application utilized by the mobile device to connect to one or more MFDs; (2) one or more MFD connection protocols available to the mobile device; (3) a user identifier; and
transmit, to the mobile device, connection instructions comprising instructions for connecting to one or more MFDs in the vicinity of the mobile device, the connection instructions selected by the trained MFD connection algorithm.

12. The device recognition system of claim 11, wherein the connection request further comprises: (4) a selection, by a user of the mobile device, of one of the one or more identified MFDs identified by the mobile device via said scanning.

13. The device recognition system of claim 11, wherein the communication interface is further configured to receive, after the mobile device connects to the one of the one or more MFDs, connection status information, wherein the connection status information is utilized to further train the MFD connection algorithm.

14. The device recognition system of claim 11, wherein the communication interface is further configured to:
receive, from the mobile device, connection failure information indicating a failure of the mobile device to connect to the one of the one or more MFDs in the vicinity of the mobile device; and
communicate, to the mobile device, connection troubleshooting instructions, wherein the connection troubleshooting instructions are selected by the device recognition system using the trained MFD connection algorithm.

15. The device recognition system of claim 11, wherein the device recognition system is a cloud-hosted implementation.

16. A multi-function device (MFD) system configured to wirelessly connect to a mobile device (182), comprising:
one or more MFDs (100); and
a device recognition system (400) remote from the one or more MFDs and comprising a trained MFD connection algorithm (464) configured to select, for the mobile device, instructions for connecting to one or more MFDs, wherein the instructions for connecting are selected by the trained MFD connection algorithm to have a highest likelihood of successfully connecting the mobile device to the one or more MFDs;
wherein the device recognition system is configured to:
receive a connection request from the mobile device, the connection request comprising at least: (1) information about an MFD connection application utilized by the mobile device to connect to one or more MFDs; (2) one or more MFD connection protocols available to the mobile device; (3) a user identifier; and
transmit, to the mobile device, connection instructions comprising instructions for connecting to one of the one or more MFDs, the connection instructions selected by the trained MFD connection algorithm.

17. The MFD system of claim 16, wherein the connection request further comprises: (4) a selection, by a user of the mobile device, of one of the one or more identified MFDs identified by the mobile device via said scanning.

18. The MFD system of claim 16, wherein the device recognition system is further configured to receive, after the mobile device connects to the one of the one or more MFDs, connection status information, wherein the connection status information is utilized to further train the MFD connection algorithm.

19. The MFD system of claim 16, wherein the device recognition system is further configured to:
receive, from the mobile device, connection failure information indicating a failure of the mobile device to connect to the one of the one or more MFDs in a vicinity of the mobile device; and
communicate, to the mobile device, connection troubleshooting instructions, wherein the connection troubleshooting instructions are selected by the device recognition system using the trained MFD connection algorithm.

20. The MFD system of claim 16, wherein the device recognition system is a cloud-hosted implementation.
